(19) United States
(12) Patent Application Publication
(10) Pub. No.: US 2003/0037023 A1
(43) Pub. Date: Feb. 20, 2003

(54) Emulation process for making changes and revisions to computer data files

(75) Inventors: Daniel Lyakovetsky, Norwalk, CT (US); Sergey Polyakov, Norwalk, CT (US)

Correspondence Address: Anderson Kill & Olick, P.C., 42nd Floor, 1251 Avenue of the Americas, New York, NY, 10020, US

(73) Assignee: INTELLICLAIM

(21) Appl. No.: 09/924,259

(22) Filed: Aug. 7, 2001

(51) Int. Cl. G06F 7/00

(52) U.S. Cl. 707/1

(57) ABSTRACT

The process of the present invention is an emulation process for automatically making changes and/or revisions to computer data files from a database of file records stored in a computer. The process includes the steps of identifying the events that occur while accomplishing a given task, recording in memory the operation of a human operator interacting with a graphical user interface of a computer to form one or more emulated responses to each event representing event handlers for performing the task, forming a collection of events for such task and a collection of the recorded emulated event handlers corresponding to each event for such task, selecting a batch of file records that require changes and/or revisions from the database of file records, loading a specified task and the recorded collection of events and emulated event handlers for such task into a computer; and executing the task on each selected file record by matching each emulated event handler in memory to a given event.

### FIELD OF THE INVENTION

The present invention relates to a process that intelligently emulates the function of a human in reviewing health claim files stored in the memory of a computer and making changes and/or revisions to the files as needed to update and/or make corrections.

### BACKGROUND OF THE INVENTION

A system that can emulate the function of a human interacting with a computer for editing file records stored in the computer has general utility in the claims payment field, and more particularly medical claims, where claims require constant attention and updating. At present, a large staff of human personnel is employed simply to review the claim files stored in the memory of a computer, select those files that require changes representing additions, deletions and/or revisions and make appropriate entries to the files.

The human review process involves extracting claim files from memory that need correction, identifying the changes to be made, and processing the files so as to incorporate the changes and/or revisions. Automation presently exists to recognize files stored in memory that need to be changed, extract such files and formulate a listing of the changes that need to be made for further manual processing by a human technician. The list of changes can be identified in a printout for processing by a human or converted into a machine- readable format to be automatically applied via an Applied Programming Interface (API). Automation by employing API is not always possible, especially in “known legacy” systems where open architecture API is not available, leaving the employment of a large staff of processors as the only option in making these revisions. Therefore, it would be further advantageous to have a system that can also emulate the manual processing operation of the human technician to implement each correction identified in the list of changes so that the process of editing file records can be fully automated.

A prior art system dedicated to automatic transaction processing that can emulate a human while working at a mainframe computer terminal for correcting files stored in the computer is taught in U.S. Pat. No. 5,758,341. This system utilizes a transaction-processing program that simulates the actions of a human by following a rigid sequence of programmned steps, each of which has an expected outcome for each action. If the expected outcome is not received or is not performed fully, the program comes to a halt. Accordingly, the transaction-processing program as taught in this patent is dependent upon knowing in advance a precise response to each action so that it can rigidly follow a given sequence of programmed steps corresponding to a given set of computer interactions. Unfortunately, this is not realistic since the information displayed on the graphical user interface of a computer monitor depends on the previous response of the operator which, in turn, may vary based on a multiplicity of factors all of which cannot be anticipated in advance and may not even be predictable. Furthermore, the screen layout of a graphical user interface, such as Microsoft Windows, is highly variable; an unexpected pop-up box will stymie a program that relies on a rigid sequence of programmed steps. FIG. 6b depicts the programming of each potential pathway for a rigid sequence of events when only three events are involved with only three potential paths after each event. Programming each pathway quickly becomes highly laborious. Rigid sequence programming would have to account for nine potential sequences as shown in FIG. 6b. If the path A→C→M occurred the program would fail. Accordingly, the inability to handle unexpected events, and the painstaking, time-consuming nature of such programming, makes a computer program which mandates a rigid sequence of programmed steps impractical.

### SUMMARY OF THE INVENTION

In accordance with the present invention, rather than predict in advance the sequence of every possible computer iteration and operator response to carry out a given task, the process operates in response to a collection of predetermined “event handlers” which correspond to different events that may or may not occur during the task. Each task is formulated to capture all the event handlers that emulate the responses of a user to each event that the computer terminal displays to implement a revision. Most importantly, the events in a given task are not arranged in any logical sequence. To the contrary the program is instead totally event driven. Implementation of the predetermined event handlers causes the events as they arise to be executed regardless of the order in which they arrive.

A collection of events and event handlers to implement different tasks are loaded into a computer for implementation. An example of a task that a manual processor might undertake would be adding a modifier to a procedure code on a claim. In this case all the events and event handlers that can occur while adding a modifier to a procedure code are loaded without regard to order. A list of claim files needing such a revision, such as adding a modifier, is also loaded into the computer. A task is initiated in a predetermined manner such as by selection of a claim file from the claim “look-up” in the main menu with each emulated response matched to a display event until all of the events have been matched. Each event is matched to an event handler until the last event occurs, at which time the task is deemed successful and another claim file is initiated. Alternatively, if a response is not found which matches an event the task is deemed unsuccessful but otherwise is still succeeded by an attempt on the next claim file. The file records are updated in response to the implementation of the successful tasks. A printout of the unsuccessful claim file tasks is provided for separate manual implementation, if desired, and for update of the invention's event handlers for prevention of these errors in future attempts.

The process of the present invention for automatically changing and/or revising data in a database of file records stored in a computer comprises the steps of:

identifying the events that occur while accomplishing a given task;

recording in memory the operation of a human operator interacting with a graphical user interface of a computer to form one or more emulated responses to each event representing event handlers for performing the task;

forming a collection of events for such task and a collection of the recorded emulated event handlers corresponding to each event for such task;

selecting a batch of file records that require the task to be performed to execute changes and/or revisions from a database of file records;

loading a specified task and the collection of events and emulated event handlers for such task into a computer; and

executing the task on each selected file record by matching each emulated event handler in memory to a given event.

The emulation procedure is successful when the recorded emulated event handlers successfully reproduce the actions of the claims processor. Additional optimization may involve making a determination that all possible events for accomplishing a specified task such as adding a modifier to a procedure code on a claim line have been recorded. This is accomplished through additional test claims and/or the judgment of a business users. In addition, the additional step of minimizing the interactions to eliminate unnecessary keystrokes in the emulation procedure and to parameterize the steps if needed may further optimize the process. It should be understood that the process is not limited to emulating one task at a time but rather a series of tasks may be emulated to perform a plurality of different revisions all of which can be executed in sequence at one time.

### BRIEF DESCRIPTION OF THE DRAWINGS

Other advantages of the present invention will become apparent from the following detailed description of the preferred embodiment of the invention when read in conjunction with the following drawings of which:

FIG. 1 is a schematic block diagram of a prior art manual application for implementing changes and revisions to claim records into the claims system;

FIG. 2 is a block diagram of the process of the present invention;

FIG. 3 is a flowchart of the human user emulator program of the present invention for emulating and collecting the event handlers corresponding to each event needed to implement a given task;

FIG. 4a is a flowchart of the task processing process of the present invention as it concerns the initial loading of a file of claims needing to be changed;

FIG. 4b is a flowchart of the task processing process of the present invention as is pertains to a particular claims from the file needing to be changed;

FIG. 5 is an illustrated example of a collection of events and emulated event handlers for the execution of the example task “Adding Adjustment Code to the Claim Line” in accordance with the present invention;

FIG. 6a is an example of a typical flow of events starting from a first event A at step 1 to a final event N at step 4 with two intermediate steps 2 and 3 in which step 2 includes three events B, C, and D and step 3 has three potential events for each of the three events of step 2;

FIG. 6b shows a conventional rigid programming sequence for the three step flow of events in FIG. 6a resulting in a fixed number of nine potential sequence paths, as indicated, to implement the program without permitting path deviation; and

FIG. 6c illustrates the programming process of the present invention that permits the recognition of an unknown event and does not rely on a fixed sequence of events.

### DETAILED DESCRIPTION OF A PREFERRED EMBODIMENT

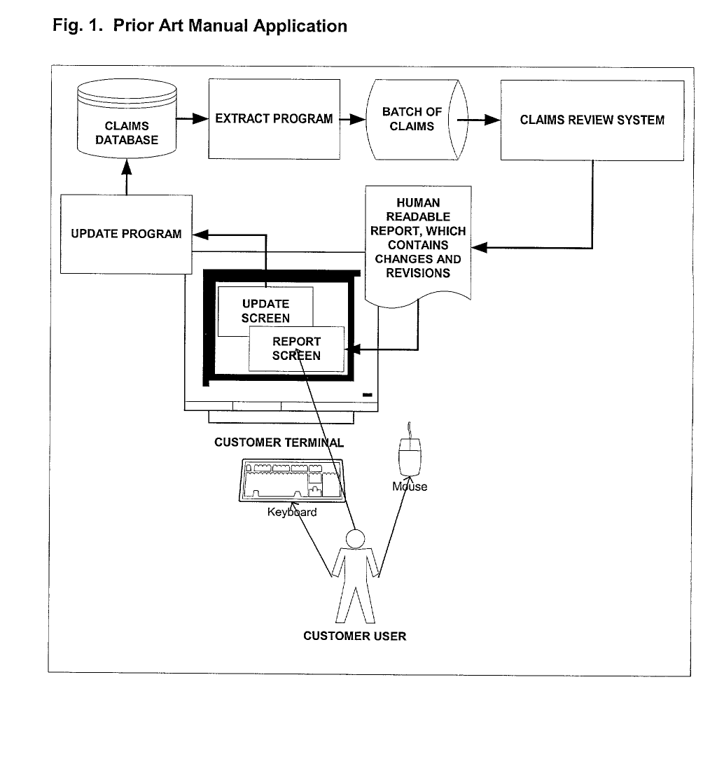

The process of the present invention uses a human user emulator program for automating tasks that need to be performed to make changes and/or revisions to claim records stored in the memory of a computer. As shown in the prior art block diagram of FIG. 1 the claims database may include e.g. tens of thousands of claims which require review and updating, when necessary, to maintain the files current. Typically one percent of the database of files will need revision at any one time. The prior art procedure employs a conventional extraction program to review the files in the database and to identify and extract a selected number of files, hereinafter referred to as a “batch of files” that needs to be updated. The files may be in an ASCII format. The batch of files are reviewed and converted into a human readable report that may be printed or formatted as an Excel or HTML type document. Alternatively, a report can be converted into an appropriate machine-readable file. In addition, an identifier may be added to each line to identify each task needed to update the file. In conventional practice, the customer views the report as shown in FIG. 1 on the computer screen and manually interacts with the graphical user interface of a computer using a keyboard and/or a mouse to enter the changes in the selected files.

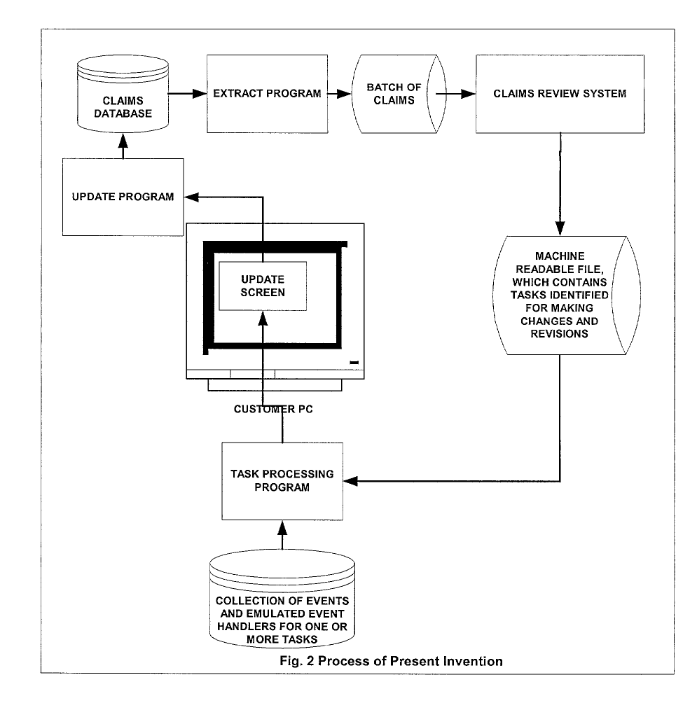

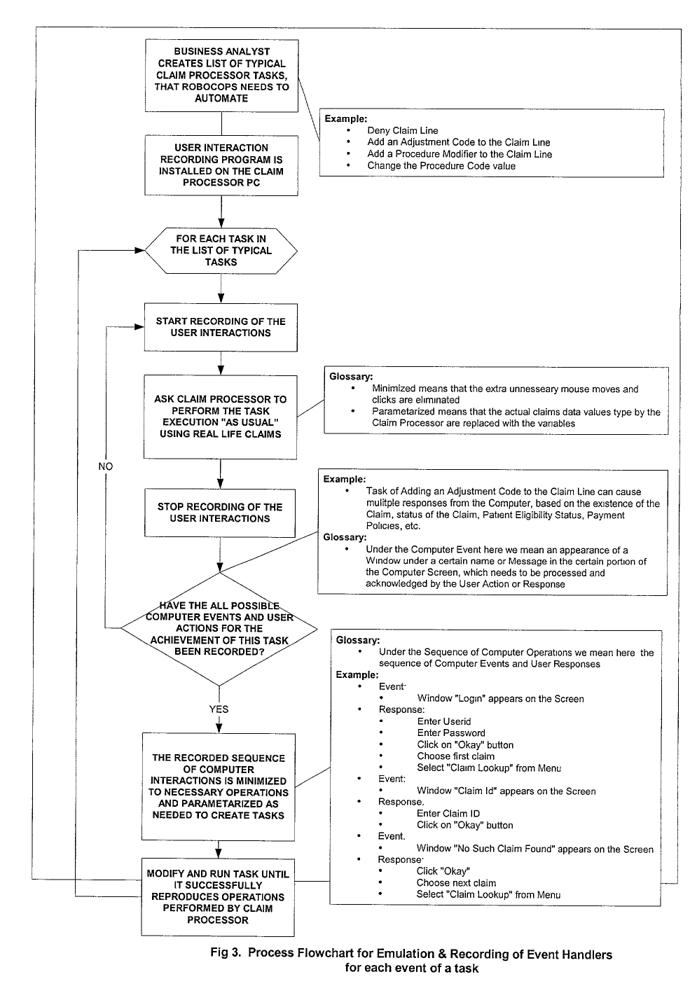

The process of the present invention as is illustrated in FIG. 2 defines an automated application for implementing changes and/or revisions to selected computer file records. The process may use a conventional extraction program as discussed in connection with the prior art manual application of FIG. 1 for extracting a selected batch of files 12 from the claims database 10. The selected batch of files 12 may be reviewed manually or automatically as in the prior art application of FIG. 1 to identify the desired changes and/or revisions that need to be made and a list of the desired changes is converted into a machine-readable file. The conversion to a machine-readable file is also conventional. In addition, each task required to be implemented may be identified with an identifier for making changes and revisions as is well known to those skilled in the art. The tasks are implemented using the task processing program and the human user emulator program in which events and emulated event handlers for each task are collected as further explained hereafter in connection with FIGS. 3 through inclusive.

FIG. 3 is a flowchart of the human user emulator program of the process of the present invention in which tasks are emulated by recording and collecting the event handlers corresponding to user revisions or corrections for each event of a given task that must be performed on an existing file record for updating the file record. The following are examples of several typical tasks: (a) Deny Claim Line; (b) Add an “adjustment code” to the Claim Line; 3. (c) Add a “procedure modifier” to the Claim Line; and (d) change the “procedure code value”. A task is emulated by recording the user interactions between a human operator and a computer in response to each event displayed on the graphical user interface of a computer monitor when performing a given revision. All of the user interactions are recorded in memory. Any conventional recording program may be used to store in memory the user interactions for each displayed event. As is shown in FIG. 3 any real or simulated claim file may be used. The information displayed in a particular position on the graphical user interface may be in the form of a message represented by a combination of words that requires a response from the operator thereby qualifying as an “event” for purposes of the present invention. The response may simply require a single “click” on the computer mouse or a reply using e.g., a sequence of computer operations to provide a complete response to the “event.” The operator determines how to appropriately respond to an event. The complete operator response qualifies as an “event handler” for purposes of the present invention. Table I, as shown below, is a glossary of examples of different events which may be displayed on the screen of the computer monitor and typical operator responses “event handlers” to such events. Each event and each user response thereto is recorded in memory.

TABLE I

| Event | | Response |
|---|---|---|
| 1. | Windows “Login” appears | Enter User ID |
| | on screen | Enter Password |
| | | Click on “Okay” button |
| | | Choose first claim |
| | | Select “Claim look-up” from Menu |
| 2. | Window “Claim Id” appears | Enter Claim ID |
| | on screen | Click “Okay” |
| 3. | Window “no such claim found” | Click “Okay” |
| | appears on screen | Choose next claim |
| | | Select “claim look-up” from Menu |

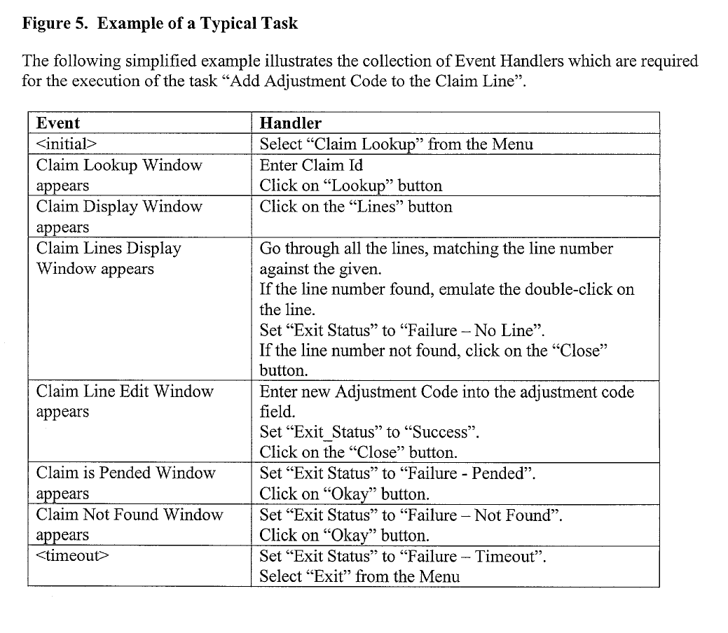

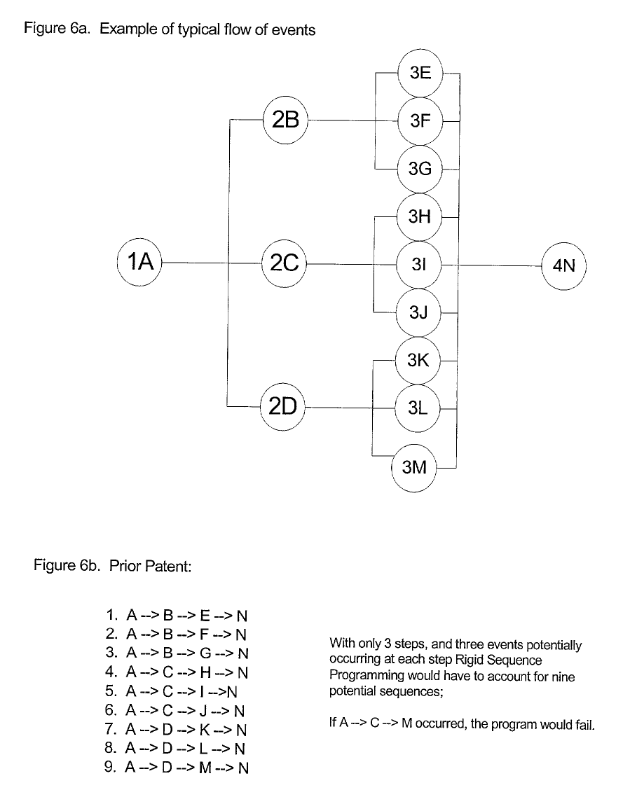

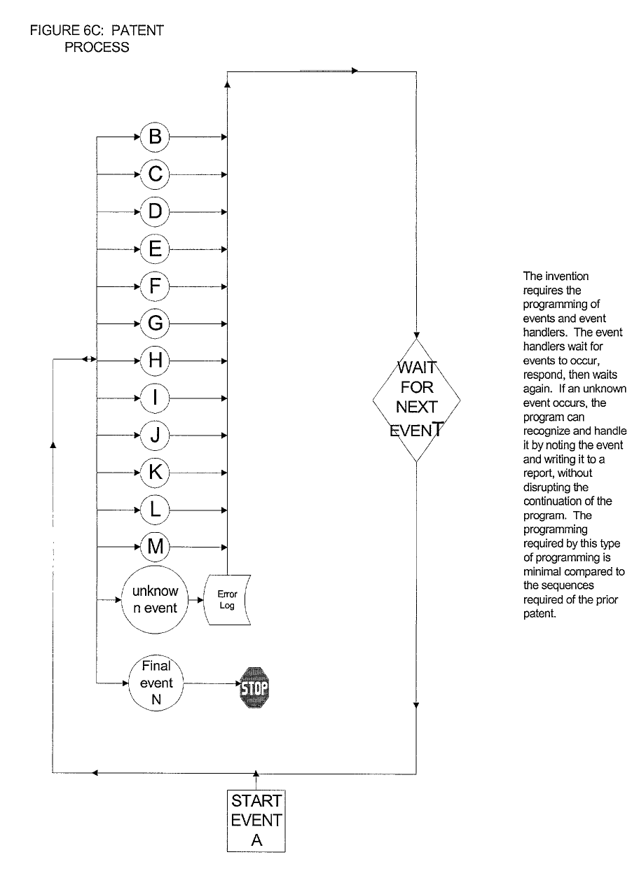

A task is emulated in accordance with the present invention by recording of all the events and user responses i.e. “event handlers” needed to perform the task and collecting in memory the recorded event handlers for each event. The emulated task is optimized in accordance with the flowchart of FIG. 3 by continually repeating the task until all of the operator responses thereto have been recorded and thereby fully emulated. Optimization may also include the step of reducing the operator responses to a limited number of necessary operations, eliminating the unnecessary actions. An example of this would correspond to extra and/or unnecessary mouse movements and clicks by the operator such as pressing the “forward button” and the “back” button on the keyboard in sequence which if not eliminated by optimization would otherwise be emulated as part of an event handler. The emulated task is then “parameterized” to include variables as a substitute for fixed values entered by the operator in the response to an event—an example of this would be where the actual claims date values corresponding to the specific file record being updated in the emulation process is replaced with variables such as MM/DD/YYYY. FIG. 5 is an example of the events and event handlers after optimization for the typical task of adding an adjustment code to the claim line. Note that a “timeout” event corresponds to an event handler that is to set the exit status to failure and exit the menu.

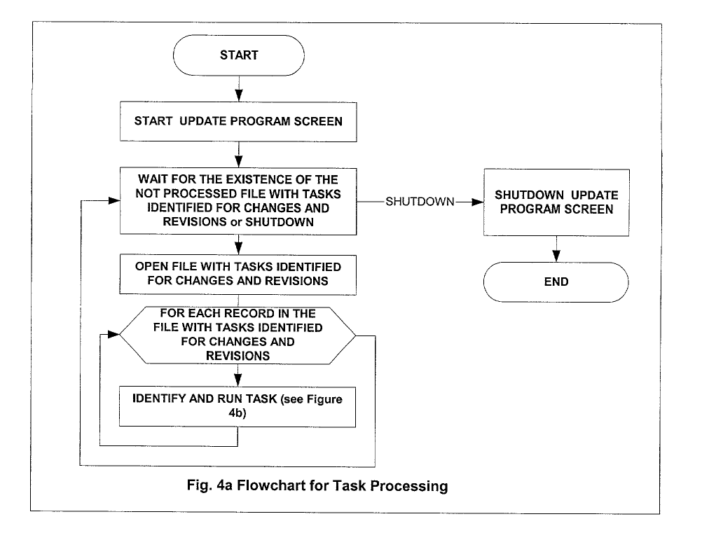

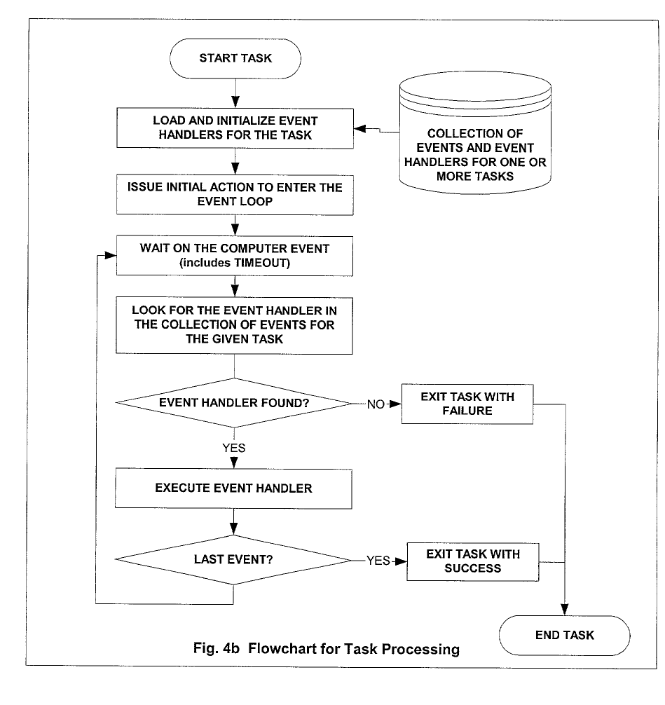

Once the tasks are emulated using the human user emulator program as depicted in the flowchart of FIG. 3 the process of FIG. 2 can be implemented. The task processing program of FIG. 2 follows the flow chart of FIGS. 4a and 4b. As shown in FIG. 4a the events and emulated event handlers for an identified task, as well as a file of claims needed the action of the specified task, are loaded into the customer PC and a first event is initialized. FIG. 4b demonstrates the flow of events for a particular claim from the loaded file. The order of events are random with the program executing the emulated event handlers for each process event independent of their sequence until the last event is successfully implemented or until a timeout event is recognized at which time the program looks at the next file or shuts down if all of the files have been revised. Each event is matched to an event handler until the last event occurs, at which time the task is deemed successful and another claim file is initiated. Alternatively, if a response is not found which matches an event the task is deemed unsuccessful but otherwise is still succeeded by an attempt on the next claim file. The file records are updated in response to the implementation of the successful tasks.. A printout of the unsuccessful claim file tasks is provided for separate manual implementation, if desired, and for update of the invention's event handlers for prevention of these errors in future attempts.

What we claim is:

1. A process for automatically changing and/or revising data in a database of file records stored in a computer comprising the steps of:
identifying the events that occur while accomplishing a given task;
recording in memory the operation of a human operator interacting with a graphical user interface of a computer to form one or more emulated responses to each event representing event handlers for performing the task;
forming a collection of events for such task and a collection of the recorded emulated event handlers corresponding to each event in such task;
selecting a batch of file records that require the task to be performed to execute changes and/or revisions from a database of file records;
loading a specified task and the collection of events and emulated event handlers for such task into a computer; and
executing the task on the selected file record by matching each emulated event handler in memory to a given event.

2. A process as defined in claim 1 wherein the events loaded into the computer are randomly executed with each event being matched to an event handler until the last event occurs at which time the task is deemed successful and another task is loaded for execution.

3. A process as defined in claim 2 wherein if no response is found that matches an event the task is deemed unsuccessful followed by the step of either loading another file for modification or another task.

4. A process as defined in claim 3 further comprising updating file records when a task is deemed unsuccessfully executed followed by providing a printout of the unsuccessful claim file.

5. A process as defined in claim 3 wherein the file records are selected consecutively for implementing a given task.

6. A process as defined in claim 2 further comprising the step of minimizing the interactions in the emulation procedure to optimize the selection of event handlers for each event so as to reduce or eliminate unnecessary steps.

7. A process as defined in claim 6 wherein each emulated task is parameterized to include variables as a substitute for fixed values entered by the operator in response to an event.

8. A process as defined in claim 2 wherein the recording of each event for each task is analyzed to determine that all possible events needed to accomplish a specified task have been performed and if not the emulation procedure is repeated.

9. A process as defined in claim 1 further comprising the step of rerunning the task until the recorded emulated event handlers successfully reproduce the actions of the claims processor.
